(19) United States
(12) Patent Application Publication
(10) Pub. No.: US 2016/0005035 A1
(43) Pub. Date: Jan. 7, 2016

(54) SECURE FINANCIAL TRANSACTION USING PLAIN TEXT SMS

(71) Applicant: Mistral Mobile, Oulu (FI)

(72) Inventors: Ludwig Schulze, Forest Hills, NY (US); Timo P. Tervo, Oulu (FI)

(21) Appl. No.: 14/322,276

(22) Filed: Jul. 2, 2014

(51) Int. Cl. G06Q 20/40; H04L 29/06; H04W 4/12

(52) U.S. Cl. CPC G06Q 20/401; H04W 4/12; G06Q 20/4012; H04L 63/0435; G06Q 2220/00

(57) ABSTRACT

Methods and apparatus, including computer program products, are provided secure payments. In one aspect there is provided a method. The method may include initiating, by an application at a user equipment, generation of a short message service message to carry at least financial transaction information; generating, in response to the initiating, a plaintext descriptor portion and an encrypted portion, wherein the plaintext descriptor portion provides a plaintext representation of the financial transaction information carried by the short message service message, and wherein the encrypted portion includes the financial transaction information in an encrypted form; and sending, via the short message service message, the plaintext descriptor portion and the encrypted portion. Related apparatus, systems, methods, and articles are also described.

### FIELD

The subject matter described herein relates to mobile payments.

### BACKGROUND

Mobile payments made via cellphones and smartphones are becoming ubiquitous in many parts of the world. Specifically, a user of a cell phone may make purchases, replenish an account, pay bills, and perform other transactions via the cell phone.

### SUMMARY

Methods and apparatus, including computer program products, are provided for secure financial transactions.

In one aspect there is provided a method. The method may include initiating, by an application at a user equipment, generation of a short message service message to carry at least financial transaction information; generating, in response to the initiating, a plaintext descriptor portion and an encrypted portion, wherein the plaintext descriptor portion provides a plaintext representation of the financial transaction information carried by the short message service message, and wherein the encrypted portion includes the financial transaction information in an encrypted form; and sending, via the short message service message, the plaintext descriptor portion and the encrypted portion. Related apparatus, systems, methods, and articles are also described.

In some variations, one or more of the featured disclosed herein including one or more of the following features can optionally be included in any feasible combination. The application may include a mobile payment application. The initiating may be performed in response to a data connection being unavailable or not allowed at the user equipment. The encrypted financial transaction information includes at least one of account information, a card number, a personal identification number (PIN), or cardholder information. The plaintext descriptor may include at least one of a destination phone number, an amount, a currency, an indication of secrecy, and/or a descriptor of a transaction type being carried by the short message service message. The encrypted portion may be performed using symmetric encryption. A user interface may present the short message service message including the plaintext descriptor portion and the encrypted portion.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts an example system for plaintext verification, in accordance with some example embodiments;

FIG. 1B depicts an example of a user interface, in accordance with some example embodiments;

FIG. 2 depicts an example process for plaintext verification, in accordance with some example embodiments;

FIG. 3 depicts an example apparatus, in accordance with some example embodiments;

FIG. 4 depicts an example process for encrypting messages, in accordance with some example embodiments; and

FIG. 5 depicts examples of key collections, key parts, symmetric keys, messages, and/or the like, in accordance with some example embodiments.

Like labels are used to refer to same or similar items in the drawings.

### DETAILED DESCRIPTION

Mobile payments systems may use secure short message service (SMS) to pass financial information. Moreover, the SMS may be used, when a data connection, such as an Internet Protocol (IP) connection, is not available or allowed (for example, in some emerging markets, data connections may not be available or usage may be limited due to cost). Moreover, in order to send an SMS message directly from an application on a user equipment, some operating systems require user review or interaction. Specifically, the SMS message contents may be presented on a user interface at the user equipment, so that a user can view the SMS message content and confirm the sending of the SMS message. However, if the SMS message is encrypted (which may be the case to protect financial information), a user may be not be comfortable proceeding with the sending of an SMS message as the SMS message content will appear as garbled, encrypted text.

In some example embodiments, the subject matter disclosed herein may provide an SMS message containing a plaintext descriptor portion and an encrypted portion. The encrypted portion may secure financial transaction information, such as account information and the like. The plaintext descriptor portion may provide plaintext information regarding the transaction, such as the type of transaction being carried by the short message service message. As such, when the SMS message is sent directly from for example an application, such as a mobile payment application, a user can view the SMS message including the plaintext descriptor portion and the encrypted portion. When this SMS message is viewed at a user interface before sending, a user is provided plaintext or human-intelligible information. For example, the user interface at a user equipment may present a plaintext transaction description (for example, a description of the type of transaction, summary information of transaction, and the like) in a plaintext, human-readable form, but any sensitive financial data, such as personal account information, card number, PIN, or other cardholder data, remain encrypted.

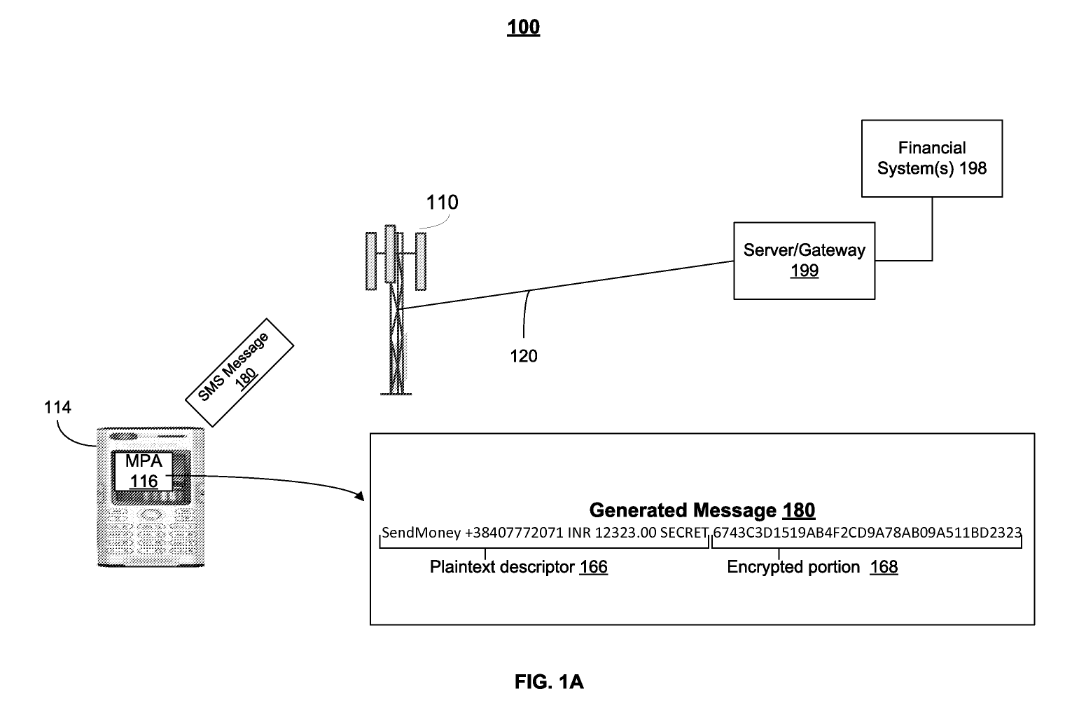

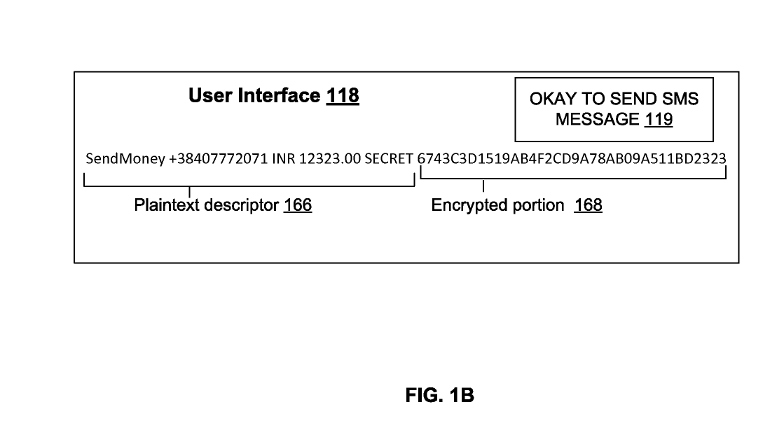

FIG. 1A depicts an example implementation of a system 100, in accordance with some example embodiments.

The system 100 may include a user equipment 114, such as a smartphone, cell phone, and/or any other type of wireless device. The user equipment 114 may include at least one application, such as a mobile payment application (MPA) 116. When mobile payment application 116 attempts to send a secure SMS message to financial system 198 (via base station 110, backhaul link 120, and/or gateway 199), the mobile payment application may generate message 180. The generated message 180 includes a plaintext descriptor 166 that provides plaintext information regarding the transaction. The generated message 180 also includes an encrypted portion 168 that secures financial transaction information. The generated message 180 may thus enable a user to view human-readable/plaintext information when the generated message 180 is sent. For example, if the operating system at the user equipment requires a user to preview and approve the sending of the SMS message 180, the user will be able to view at least a portion of message 180 and understand the type of message being sent. FIG. 1B depicts an example user interface 118 at user equipment 114. In the example of FIG. 1B, user interface 118 may show SMS message 180 including plaintext descriptor 166 portion and the encrypted portion 168. User interface 118 may also provide a user interface element 119, where approval for sending message 180 can be provided.

Referring again to FIG. 1A, the generated SMS message 180 may include plaintext descriptor 166. The plaintext descriptor may provide a summary of the transaction type (for example, “SendMoney”), the destination phone number (for example, +38407772071″ where the SMS message is being sent), a currency symbol (for example, “INR” which represents Indian Rupees), the transaction amount (for example, “12323.00”), and/or an indicator that the subsequent message text is encrypted (for example, “SECRET”). The generated SMS message 180 may also show secure container 168 having the encrypted portion, which in this example represents the cardholder's personal account information. Thus, the generated SMS message 180 may enable presentation at the user interface of user equipment 114 the following:
SendMoney +38407772071 INR 12323.00 SECRET 6743C3D1519AB4F2CD9A78AB09A511BD2323.

The secure container 168 may have a certain size, such as 32 plus 2 characters. The 32 plus 2 characters is equal to AES 128 bit encrypted data in base64 format and 2 additional characters to carry the encryption key index information, although other sized containers may be used as well.

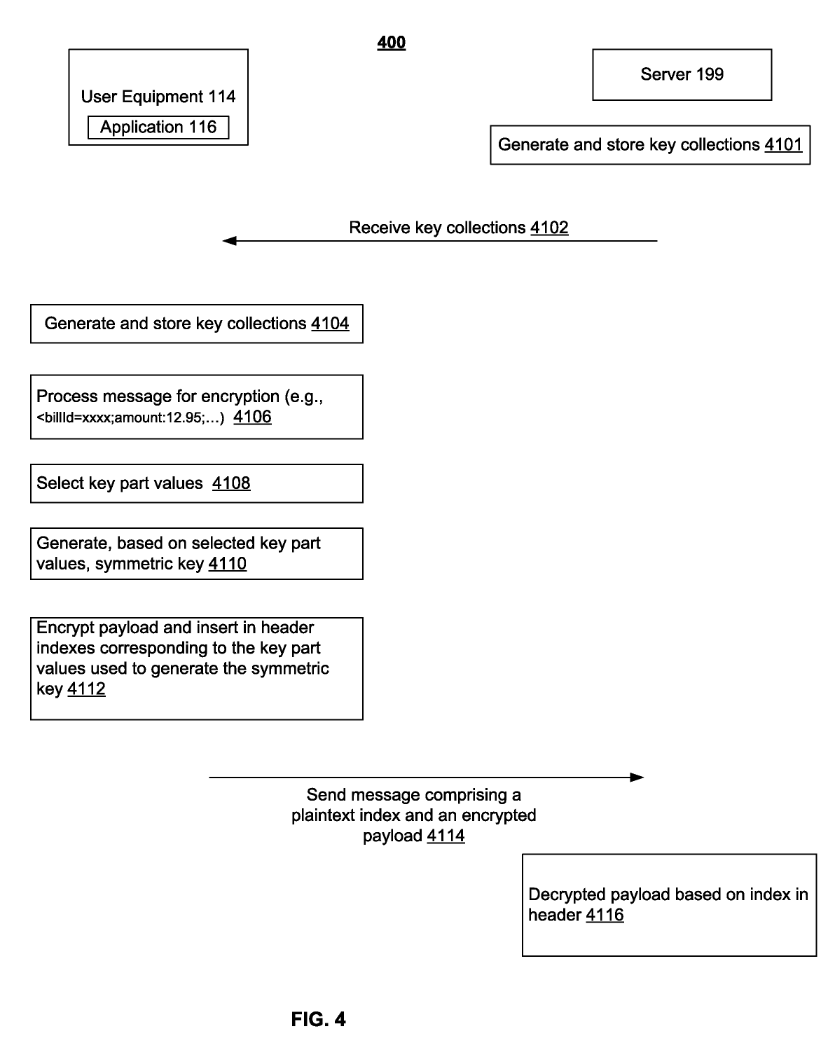

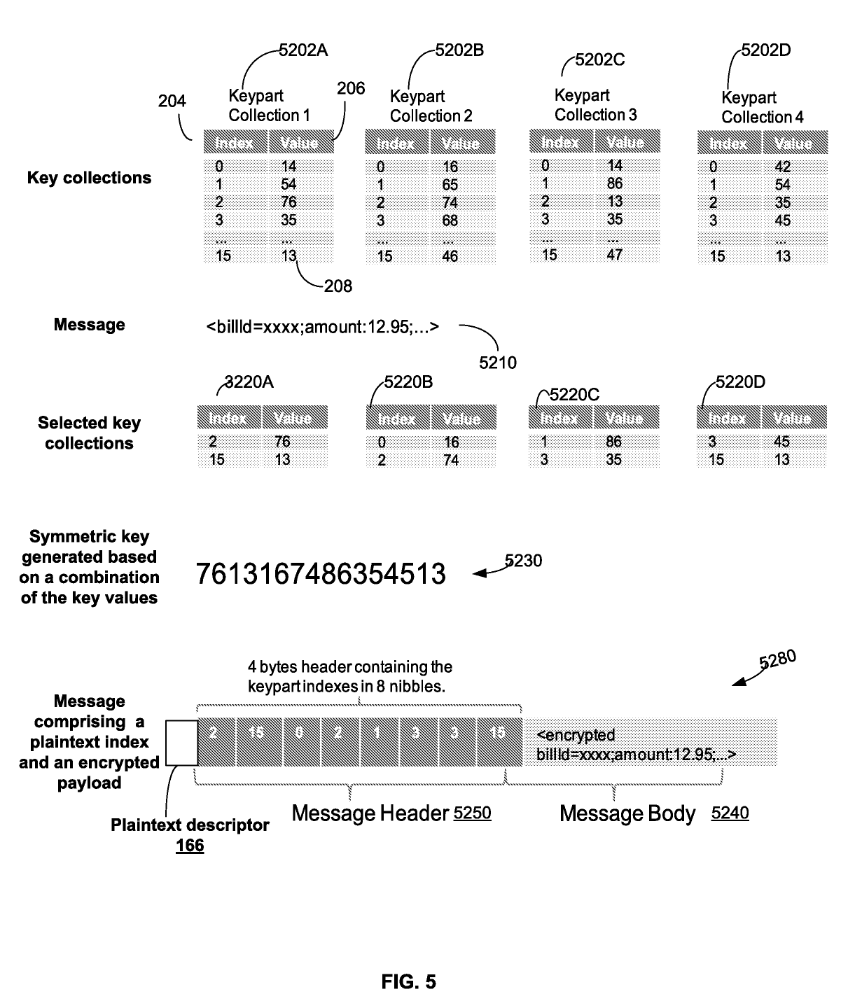

In some example embodiments, symmetric key encryption may be used to secure the cardholder's financial information in the secure container 168, and this symmetric encryption may be in accordance with the symmetric encryption described below with respect to FIGS. 4 and 5, although other types of encryption may be used as well. The client mobile payment application 116 may construct an Advanced Encryption Standard symmetric encryption key from the parts of the key that are known by a service provider (e.g., gateway 199, financial system 198, a financial entity, a payment network, and/or other node serving as a destination for message 180). Each key index and its related parts are unique for each user and the system can only decrypt the message when it knows the sender as described below with respect to FIGS. 4 and 5.

The following depicts another example of the contents of SMS message 180 where credit card information is carried:
SendCard x-1231 INR 22312.00 CARD and SECRET 6743C3D1519AB4F2CD9A78AB09A511BD1212.

In this example, the plaintext description indicates in a plaintext, human-readable format that card information is being sent (e.g., “SendCard”). The plaintext, human readable information also includes the last four numbers of the credit card, 1231, and the amount of 22312.00. The plaintext “CARD” and “SECRET” give a reader an indication that the unintelligible text that follows is card information in a secret (or cypher) form. Generally, the last four digits of a credit card number can be shared in an unsecure manner per Payment Card Industry Data Security Standard (PCI DSS). However, the credit card information as a whole is encrypted as shown by the scrambled or unintelligible information, such as “6743C3D1519AB4F2CD9A78AB09A511BD1212.”

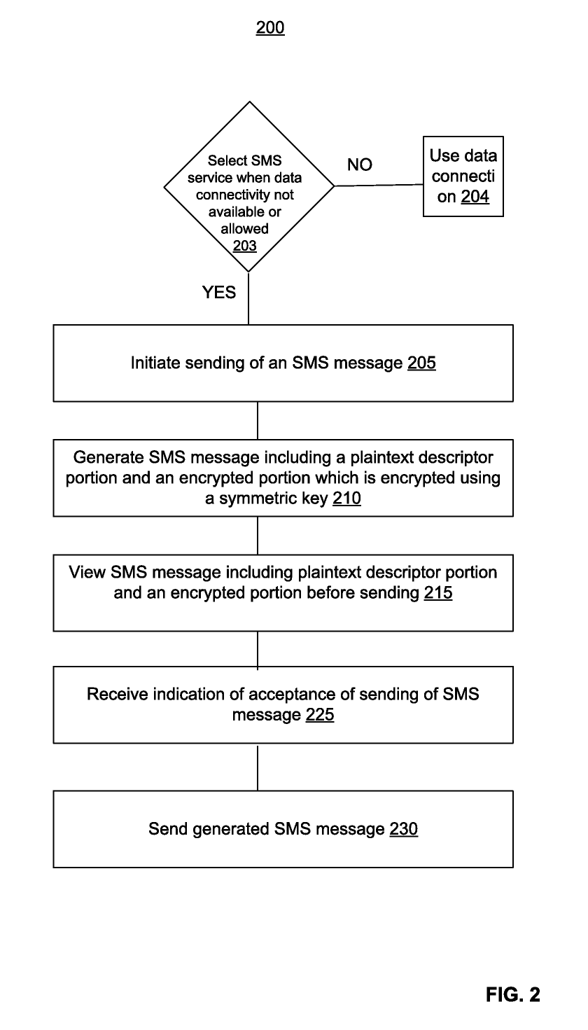

FIG. 2 depicts an example process 200 for secure SMS transmission including a plaintext portion of the SMS message, in accordance with some example embodiments. The description of FIG. 2 also refers to FIG. 1A.

At 202, when a data connection, such as an IP connection, is not available or allowed to be used at user equipment 114, user equipment 114 (or a communications controller therein) may select use of an SMS connection to the base station (or wireless access point) 110, in accordance with some example embodiments. If however, there is an IP connection available or allowed, the user equipment 114 may select use, at 204, of the data connection, rather than SMS. In some implementations, a communications controller may select the IP connection or SMS connection, although the selection may be performed in other ways (for example, based on a user selection or preference).

If SMS is selected (yes at 202), the sending of an SMS message may be initiated at 205, in accordance with some example embodiments. For example, when mobile payment application 116 seeks to send financial information, such as credit card information to make a payment, a request for token, and/or the like, to gateway 199 and/or financial system 198, an SMS message may be generated to carry the financial information. A portion of the financial information may be encrypted, and the encryption may be symmetric encryption as described further below, although other types of encryption may be used as well. The generated SMS message may thus carry a plaintext descriptor 166 of the transaction as well as an encrypted portion 168 including the encrypted financial information. The plaintext portion enables a user to recognize the type of transaction being carried by the SMS message 180.

At 210, an SMS message may be generated, and the generated SMS message may include a plaintext descriptor portion and an encrypted, in accordance with some example embodiments. For example, the user equipment 114 may generate SMS message 180 which includes a plaintext descriptor 166 and a security container 168. The security container in this example includes“6743C3D1519AB4F2CD9A78AB09A511BD23 23.” The security container may be encrypted using symmetric encryption, although other types of encryption may be used as well. The plaintext descriptor 166 includes a plaintext “SendMoney +38407772071 INR 12323.00.” The “SECRET” is in plaintext to signal to a user that the subsequent symbols/text are encrypted. In some example embodiments, mobile payment application 116 may provide the plaintext used for the plaintext descriptor portion. For example, mobile payment application 116 knows the type of transaction being performed, so mobile payment application 116 may provide the plaintext descriptor(s).

At 215, the generated SMS message may be viewed before the message is sent, in accordance with some example embodiments. The SMS message 180 may be viewed, at 215, in a user interface. For example, before being sent, SMS message 180 may be viewed at a user interface at user equipment 114. Because of the plaintext descriptor 166, the user interface may allow viewing of a general description of the financial information carried by the secure, encrypted portion 168 (which may appear garbled, scrambled, or otherwise unintelligible at the user interface).

Moreover, in some implementations, a user may be prompted by for example the user interface to approve the sending as depicted at FIG. 1B. When this is the case, the user equipment 114 may receive, at 225, an indication of acceptance of the sending of the SMS message 180.

At 230, SMS message 180 may be sent to for example, gateway 199 and financial system 198 for processing.

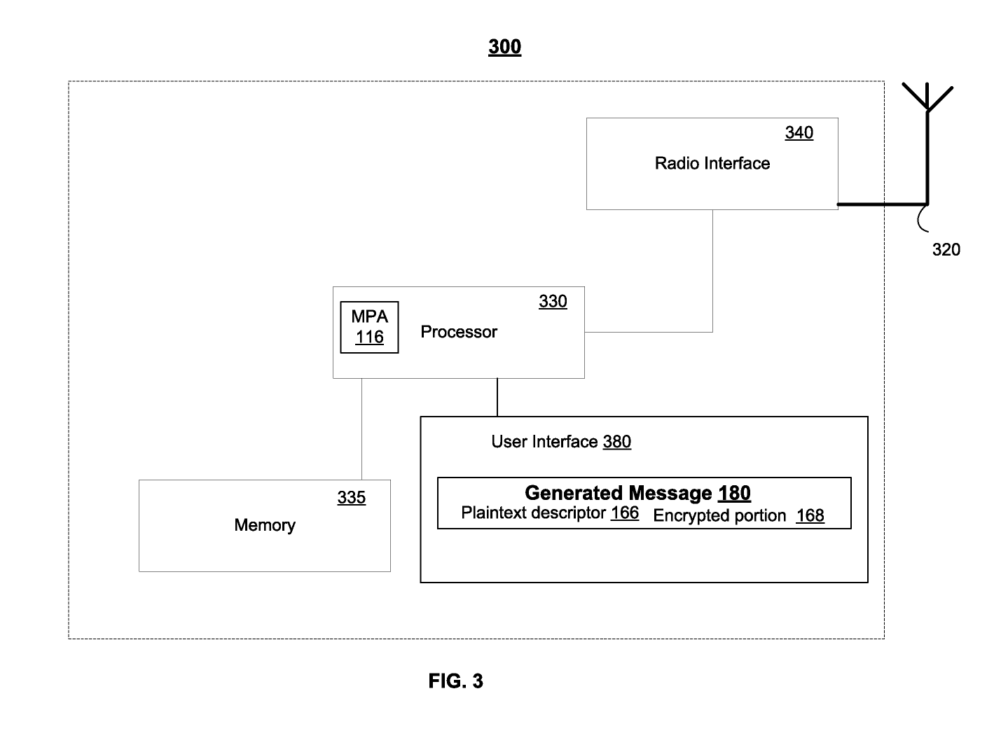

FIG. 3 depicts an example apparatus 300, in accordance with some example embodiments. Apparatus 300 may be implemented as user equipment 114. The apparatus 300 may include mobile payment application 116. The apparatus may also include a user interface 380 depicting generated SMS message 180 which includes a plaintext descriptor 166 of the encrypted portion 168. The apparatus may send the SMS message 180 to gateway 199 and/or financial systems server 199 via an access point, such as a base station 110 (e.g., a base station of a public land mobile network), a wireless access point (e.g., WiFi access point), and/or any other mechanism capable of handling an SMS message. The access point may include wired and/or wireless backhaul links 120 to other devices, networks, and/or the like, to enable access to gateway 199 and/or server 198. In some example embodiments, gateway 199 may decrypt the SMS message, as described below with respect to FIGS. 4 and 5, and then provide the decrypted SMS message to financial system server 198 configured to handle and/or process the decrypted financial information. For example, the decrypted message may be posted to an account to make a payment represented by the SMS message, although other types of financial transactions/information may also be carried by the SMS message as well.

Although some of the examples described herein refer to SMS to carry the plaintext descriptor 166 of the encrypted portion 168, the plaintext descriptor 166 of the encrypted portion 168 may be carried by other types of messages as well.

The apparatus 300 may also include one or more antennas 320 for receiving a downlink and transmitting via an uplink. The apparatus 300 may also include a radio interface 340, which may include other components, such as filters, converters (e.g., digital-to-analog converters and/or the like), symbol demappers, signal shaping components, an Inverse Fast Fourier Transform (IFFT) module, and/or the like, to process symbols carried by a downlink or an uplink. In some implementations, the apparatus 300 may also be compatible with WiFi, Bluetooth, GERAN, UTRAN, E-UTRAN, first generation (1 G) communication protocols, second generation (2G or 2.5G) communication protocols, third-generation (3G) communication protocols, fourth-generation (4G) communication protocols and/or any other standards, radio access technologies, and specifications as well. Moreover, the apparatus 300 may be configured to support messaging, such as SMS messages. The apparatus 300 may further include at least one data processor, such as data processor 330 (e.g., a microprocessor and/or the like) for controlling apparatus 300 and for accessing and executing program code stored in memory 335. For example, memory 335 may include code for performing one or more of the operations associated with respect to the user equipment.

The following describes an encryption approach which may be used in some example embodiments. Specifically, a mobile payment application (for example, mobile payment application 116) may receive a key collection including a plurality of key parts. These key parts may include key values and indexes. A key value represents a portion of a symmetric key, and an associated index identifies the key value in a certain key collection. For example, when information is received for secure transmission by the mobile application, the mobile application may select 2 key parts (i.e., key values and corresponding indexes) from each of the 4 key collections, although other quantities of key values and key collections may be used as well. The mobile application may then combine the selected key values to form a symmetric key, which is then used to encrypt the received information. The mobile application may then generate a short message service (SMS) message carrying at least a header portion and a payload portion. The payload may include the encrypted information, and the header may represent the indexes identifying which key values were selected to form the symmetric key. The SMS payload portion may also include a plaintext portion 166 as noted above to give a user an indication of whether it is okay to send the SMS message to a destination, such as gateway 199 and the like. The mobile application may then send the SMS message to a preview pane 118 to obtain user approval before sending the SMS message to gateway 199 and the like, where the SMS message can be decrypted.

In some example embodiments, the symmetric key is dynamically generated in the sense that each piece of information, such as financial transaction information, requiring transmission to the server/gateway 199 is encrypted with a unique, one-time key. Moreover, the key collections at the mobile application may be updated with another key collection, when the possible key combinations have been exhausted, when the keys have been compromised, and/or any other time new key collections are desired. The subject matter disclosed herein may, in some example implementations, provide symmetric encryption for SMS communication and the like using a dynamic, one-time use symmetric key formed from key parts shared by the sender and receiver.

FIG. 4 depicts an example process 400 for providing secure transactions, in accordance with some example embodiments. The description of FIG. 4 also refers to FIG. 5.

In some exemplary embodiments, user equipment 114 may be implemented as a mobile wireless device. The user equipment 114 may be referred to as, for example, a mobile station, a mobile unit, a subscriber station, a wireless terminal, a tablet, a smart phone, a cell phone, and/or the like. The user equipment may be implemented as, for example, a wireless handheld device, a wireless plug-in accessory, and/or the like. In some cases, the user equipment may include a data processor, a computer-readable storage medium (e.g., memory, storage, and/or the like), a radio access mechanism, and/or a user interface. Moreover, the user equipment may include one or more applications, such as application 116 stored as code in memory and executable by a data processor. Furthermore, user equipment 114 may be configured to send SMS messages, via wireless, to an SMS aggregator, which may forward the SMS message to gateway 199.

Server/gateway 199 may include a data processor and a computer-readable storage medium (e.g., memory, storage, and/or the like). In some example embodiments, server 199 may be implemented as gateway having a first interface to a SMS aggregator (and/or SMS provider) and a second interface to other systems, such as financial systems 198, such a mobile payment networks, financial institutions, payment processors, credit card processors, and/or the like.

At 5402, the server 199 may generate and store key collections. For example, server 199 may comprise a data processing device configured to generate key collections. Specifically, server 199 may randomly generate and store key collections, each of which includes indexes and corresponding key values. The key values represent portions of a symmetric key, and when some of these portions are combined, the combined portions form a symmetric key used to encrypt information using a symmetric encryption engine, such as AES and/or the like. In some example embodiments, server 199 includes a security module that generates, or receives from a key generator, 4 key collections, as depicted at FIG. 5 (although other quantities may be used as well). These key collections may then be securely stored at server 199.

The example of FIG. 5 depicts 4 key collections 5202A-D, and the key collections include indexes 5204 and key values 5206. Each of the indexes uniquely maps, and thus identifies, a certain key value. In some example embodiments, each of the key collections includes 16 key parts, each comprising an index and a key value. For example, these 16 key parts at key collection 5202A comprise index 0 and key value 14, index 1 and key value 54, index 2 and key value 54, and so forth through index 15 and corresponding key value 13. Moreover, any key value can be identified uniquely based on its collection and index. For example, key value 13 (at 5208) can be uniquely identified by specifying the key collection and index, which in this example is key collection 1 and index 15 (e.g. 1, 15). In any case, the key values can be combined by, for example, concatenating the key values to form a symmetric key as further described below. In some example embodiments, additional layers of security may be provided so long both endpoints are aware of those additional layers to enable processing. For example, key values may be built in other ways from the shared key collection and index information so long as both endpoints are aware of the way being used.

Referring again to FIG. 4 at 4102, once the key collections are generated, server 199 may store the key collections in a secure manner, such as using a dedicated secure storage mechanism including, for example, a hardware security module (HSM).

At 4404, the server 199 may send the key collections generated and stored at 5102 to user equipment 114. For example, server 199 may share the key collections 5202A-D with user equipment 114 including mobile payment application 116 by sending the key collections 5202A-D. In some example embodiments, the key collections may be sent via at least a wireless link carrying an encrypted SMS message as disclosed herein (e.g., an index and an encrypted payload, using for example AES, as disclosed herein), although the key collections may be sent in other ways as well. For example, when the client device, such as user equipment 114, connects to server 199 for the first time, user equipment 114 may obtain the initial key collections (and/or other software and/or data for the application 116) via a secure connection using, for example, a shared service public key. After that initial key collection delivery, the encrypted SMS messages disclosed herein may be used to share the key collections.

Once the user equipment 114 receives the key collections, user equipment 114 may then store at 4104 the key collections. Moreover, the application 116 and/or user equipment 114 may receive key collections 5202A-D and then store the key collections 5202A-D securely using, for example, local encrypted, or otherwise secure, storage.

At 4106, a message may be processed for encryption, in accordance with some example embodiments. For example, mobile payment application 116 and/or user equipment 114 may have a message for transmission, such as a bill pay message (“<billId=xxxx;amount:12.95>”) 5210 at FIG. 5. In this example, the message represents a financial transaction to be carried by an SMS message securely, and, in particular, a user of user equipment 114 submitting bill payment to server 199.

At 4108, the application 116 at user equipment 114 may select key parts. For example, application 116 may randomly select 2 key parts from each collection, as depicted at 5220A-D at FIG. 5.

At 4110, a symmetric key may be generated, based on the selected key parts. For example, user equipment 114 and/or application 116 may select the key values from each of the selected key parts 5220A-D and then combine those key values to form a symmetric key. Referring again to FIG. 5, the generated key is 7613167486354513 (at 5230). This generated key represents the concatenation of the selected key values, 76 and 13, from the first collection, the key values, 16 and 74, from the second collection, the key values, 86 and 35, from the third collection, and the key values, 45 and 13, from the fourth collection.

In some example embodiments, the generated symmetric key may also be hashed using user equipment 110's Mobile Station International Subscriber Directory Number (MSISDN), a Bluetooth universally unique identifier (UUID), or any other identifier (which would also be known by the server 199).

At 4112, the symmetric key may be used to encrypt the message payload, and a plaintext header including indexes may be appended to the payload. The plaintext may also include a plaintext descriptor 166. In the example of FIG. 1A, the plaintext portion 166 includes “SendMoney +38407772071 INR 12323.00.” Referring again to FIGS. 4 and 5, the message payload, “<billId=xxxx;amount:12.95>” 5210 may be encrypted symmetrically using the key generated at 4110, and the encrypted payload may serve as encrypted portion 168. The indexes for the selected key collections may then be combined and inserted into a header. This header may be in plaintext, i.e., not encrypted by the symmetric key. Referring again to FIG. 5, the message body 5240 includes the encrypted payload of “<billId=xxxx;amount:12.95>.” The message header 5250 includes the indexes for the selected key values contained in the symmetric key, so that the index uniquely identifies all of the key value pieces used to form the entire symmetric key 5230. The plaintext descriptor 166 may also be left positioned as a plaintext header as shown in FIG. 5. To illustrate further, message header 5230 includes indexes 2 and 15 from the first collection 5220A, indexes 0 and 2 from the second collection 220B, indexes 1 and 3 from the third collection 5220C, and indexes 3 and 15 from the fourth collection 5220D. The message header may also include the plaintext descriptor 166. Because the message header 5230 includes the ordered indexes from each key collection 5220A-D, the server 199 will be able to determine symmetric key 5230 based on the plaintext index contained in the message header 5250. In some example embodiments, the symmetric encryption is AES, although other symmetric encryption techniques may be used as well.

Although the message header 5250 at FIG. 5 includes the indexes in a predetermined order corresponding to the collections 5202A-D, the indexes may be placed in the header in other orders as well. When this is the case, server 199 may be configured to know the index placement technique used at the user equipment to access the key values in the key collections.

In some example embodiments, the message body 5240 may also be signed using, for example, a hash as noted above. This hash may be implemented as a Secure Hash Algorithm (SHA) and/or MD5, although other hash techniques may be used as well.

In the example of FIG. 5, as symmetric key creation relies on 4 key collections from which 2 key parts among 16 are randomly selected, the amount of unique combinations is 262,144 (i.e., 4 times 2¹⁶). Moreover, the header 5250 may, in some example embodiments, contains 4 bytes reserved to receive the 8 indexes of the key parts necessary to re-generate the symmetric key for decrypting the message body 5240. Each of these indexes fit into one nibble (i.e., a half-byte whose value is between 0-15), so the 8 indexes of the key parts can be set using only 4 bytes (i.e., 8×½ byte). Although some of the examples described herein refer to specific quantities of key values, key collections, and indexes, other quantities may be implemented as well.

At 4114, the message may be sent to server 199. Referring again to FIG. 5, user equipment 114 may send message 5280 including plaintext descriptor 116, message header 5250 and message body 5240 to server 199. Moreover, message 5280 may be sent via SMS or any other connectivity channel between client and server. Specifically, user equipment 114 may provide message 5280 to an SMS interface at the user equipment 114 for sending the message 5280 via SMS. The server 199 may have an interface to an SMS provider, which provides the SMS message 5280 to server 199. In this example, the server 199 may obtain the user equipment's MSISDN from the SMS service provider and determine the key parts used based on the header 5250 carried by the SMS message.

At 5116, server 199 may decrypt the message based on the index in the header. For example, server 199 may read the header comprising 2, 15, 0, 2, 1, 3, 3, and 15 and then access the key collections to identify the key values forming the symmetric key (e.g., 7613167486354513) used by user equipment 114 to send the message. Using the symmetric key, server 199 may then decrypt the message into plaintext. When hashing is used, the server 199 may hash the symmetric key before decrypting the message.

In some example embodiments, the server 199 may send an acknowledgement message to user equipment 114 to confirm receipt of the message received by server 199 at 4110. This acknowledgement may be sent as an SMS message. Moreover, this SMS acknowledgement message may carry a payload encrypted using the same key used to encrypt the payload of the message received at 4114, although a different key may be generated using the key collections.

In some example embodiments, each generated symmetric key is used only during one request/response sequence before it is discarded. When this is the case, the user equipment 114 may store and keep a record of all the used key parts combinations. Moreover, the record may allow server 199 to reject any incoming messages that use an already-used symmetric key. Furthermore, once a certain amount of key parts combinations have been used or when the key collections (or portions thereof) have been compromised, server 199 may, in some example embodiments, decide to renew the key collections by resending a new set of key collections at 6102.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
initiating, by an application at a user equipment, generation of a short message service message to carry at least financial transaction information;
generating, in response to the initiating, a plaintext descriptor portion and an encrypted portion, wherein the plaintext descriptor portion provides a plaintext representation of the financial transaction information carried by the short message service message, and wherein the encrypted portion includes the financial transaction information in an encrypted form; and
sending, via the short message service message, the plaintext descriptor portion and the encrypted portion.

2. The method of claim 1, wherein the application comprises a mobile payment application.

3. The method of claim 1, wherein the initiating is performed in response to a data connection being unavailable or not allowed at the user equipment.

4. The method of claim 1, wherein the encrypted financial transaction information includes at least one of account information, a card number, a personal identification number (PIN), or cardholder information.

5. The method of claim 1, wherein the plaintext descriptor includes at least one of a destination phone number, an amount, a currency, an indication of secrecy, and/or a descriptor of a transaction type being carried by the short message service message.

6. The method of claim 1, wherein the generating further comprising:
encrypting the encrypted portion using a symmetric encryption.

7. The method of claim 1 further comprising:
presenting, at a user interface of the user equipment, the short message service message including the plaintext descriptor portion and the encrypted portion.

8. An apparatus comprising:
at least one processor; and
at least one memory including program code which when executed by the at least one processor causes operations comprising:
initiating, by an application at the apparatus, generation of a short message service message to carry at least financial transaction information;
generating, in response to the initiating, a plaintext descriptor portion and an encrypted portion, wherein the plaintext descriptor portion provides a plaintext representation of the financial transaction information carried by the short message service message, and wherein the encrypted portion includes the financial transaction information in an encrypted form; and
sending, via the short message service message, the plaintext descriptor portion and the encrypted portion.

9. The apparatus of claim 8, wherein the application comprises a mobile payment application.

10. The apparatus of claim 8, wherein the initiating is performed in response to a data connection being unavailable or not allowed at the apparatus.

11. The apparatus of claim 8, wherein the encrypted financial transaction information includes at least one of account information, a card number, a personal identification number (PIN), or cardholder information.

12. The apparatus of claim 8, wherein the plaintext descriptor includes at least one of a destination phone number, an amount, a currency, an indication of secrecy, and/or a descriptor of a transaction type being carried by the short message service message.

13. The apparatus of claim 8, wherein the generating further comprising:
encrypting the encrypted portion using a symmetric encryption.

14. The apparatus of claim 8 further comprising:
presenting, at a user interface of the apparatus, the short message service message including the plaintext descriptor portion and the encrypted portion.

15. A non-transitory computer-readable storage medium including program code which when executed by at least one processor causes operations comprising:
initiating, by an application at an apparatus, generation of a short message service message to carry at least financial transaction information;
generating, in response to the initiating, a plaintext descriptor portion and an encrypted portion, wherein the plaintext descriptor portion provides a plaintext representation of the financial transaction information carried by the short message service message, and wherein the encrypted portion includes the financial transaction information in an encrypted form; and
sending, via the short message service message, the plaintext descriptor portion and the encrypted portion.
